(19) United States
(12) Patent Application Publication
(10) Pub. No.: US 2007/0200476 A1
(43) Pub. Date: Aug. 30, 2007

(54) DISPLAY DEVICE

(76) Inventors: Yuuichi Kijima, Chosei (JP); Noriyuki Oroku, Yokohama (JP); Shigemi Hirasawa, Chiba (JP); Hiroyuki Tachihara, Oamishirasato (JP); Ikuo Yamaba, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/679,277

(22) Filed: Feb. 27, 2007

(30) Foreign Application Priority Data
Feb. 28, 2006 (JP) 2006-053021

(51) Int. Cl. H01J 1/62; H01J 63/04; H01J 21/10

(52) U.S. Cl. 313/308; 313/483; 345/84

(57) ABSTRACT

The present invention provides a display device allowing the quality and reliability to be improved by preventing the occurrence of vacuum leak attributable to dislocation which may be caused by preliminary baking and panel sealing.

A display device in which the end surfaces of a support body 13 are hermetically bonded to a front substrate 2 and a rear substrate 1 by sealing members 4. In the display device, the support body 13 is formed by bonding together a plurality of support body members 13X1, 13X2, 13Y1 and 13Y2, and adjacent support body members are bonded by using a first bonding member 141 for bonding a central area of each bonding surface and a second bonding member 142 for bonding a marginal area around the central area. The softening temperature of the first bonding member is set higher than the softening temperature of the second bonding member.

### CLAIM OF PRIORITY

The present application claims priority from Japanese Application JP 2006-053021 filed on Feb. 28, 2006, the content of which is hereby incorporated by reference into this application.

### BACKGROUND OF THE INVENTION

1. Field of the Invention

The present invention relates to a display device and particularly to a display device provided with a support body which is interposed between substrates so as to surround a sealed space formed between the substrates. More particularly, the invention relates to a bonding structure of a plurality of support body members forming the support body.

2. Description of the Related Art

For display devices which exhibit excellent properties such as high brightness and high definition, color cathode ray tubes have been widely used. Recently, along with the improvement of image quality of information processing devices and television broadcasting, there has been a demand for flat plate displays (panel displays) which achieve light-weight and space-saving with excellent properties such as high brightness and high definition.

Typical examples of these panel displays are liquid crystal display devices and plasma display devices which have been in practical use. Further, various other types of panel displays have also been proposed, including field emission type display device which can be superior in brightness and the organic EL display device which is characterized by low power consumption.

In some of these panel-type display devices, a sealed space which is evacuated to a lower pressure than the external atmospheric pressure or to a vacuum is formed between two substrates, namely the front and rear ones. In such a display device, a frame-like support body is interposed between the two substrates so as to maintain the air-tightness of the sealed space surrounded by the support body with a given distance between the two substrates.

FIG. 10 is a cross-sectional view of a known field emission display device for explaining a configuration thereof. In FIG. 10, the field emission display device includes a rear substrate 1 and a front substrate 2 which faces the rear substrate 2. Further, a frame-like single piece support body 3 is interposed between the two substrates. The support body 3 is bonded to the edges of the inner circumferences of the two substrates using sealing materials 4 so as to hermetically seal the inner space which constitutes a display region. The sealed space is held at a lower pressure than the external atmospheric pressure or in a vacuum state.

This display device has field emission type electron sources 5, control electrodes and the like provided on the inner surface of the rear substrate 1. Also, an anode and phosphor layers 6 are provided on an inner surface of the front substrate 2. Further, in the display region, a plurality of spacers 7 are set between the rear substrate 1 and the front substrate 2 using bonding materials 8 at intervals of a few pixels so as to maintain a give distance between the two substrates without disturbing the operation of each pixel. Spacers 7 have been necessary for large-sized display screens.

The rear substrate 1 is formed of preferably such a material as glass or ceramic while the front substrate 2 is formed of a light-transmitting material such as glass. The support body 3 is formed of preferably such a material as glass or ceramic and is fixedly secured to a marginal portion of the rear substrate 1 and to that of the front substrate 2 using the sealing material 4 such as frit glass. The inner space defined by the rear substrate 1, the front substrate 2 and the support body 3 is evacuated to a vacuum of, for example, 10.sup.-5 to 10.sup.-7 Torr.

The electron sources 5 are constituted of, for example, carbon nanotube (CNT), diamond-like carbon (DLC) or other field emission cathodes.

As known, while the support body 3 to maintain the distance between the two substrates and enclose the display region is integrally formed in the above-mentioned panel display, it is also possible to form a support body by joining a plurality of wall members as shown in FIG. 11. FIG. 11 is an explanatory view of a display device which is disclosed in Japanese Patent Laid-Open No. 2002-298761 (Patent Document 1). Further, FIG. 11 is a developed perspective view for schematically explaining how a rear substrate 1, a front substrate 2 and a support body 3 are assembled in this example.

In the display device shown in FIG. 11, the rear substrate 1 and the front substrate 2 are glass plates while the support body 3 is formed of a glass material. Here, various kinds of constituent parts which are formed on the respective inner surfaces of the rear substrate 1 and the front substrate 2 are omitted from the drawing.

In FIG. 11, the support body 3 having a certain thickness is interposed between the rear substrate 1 and the front substrate 2. The support body 3, which is fixed to the edges of the inner circumferences using a sealing material, forms an inner sealed space which is uniform in thickness. Note that this support body 3 is formed from a plurality of separate wall members 3X1, 3X2, 3Y1, 3Y2 and 3C1 to 3C4.

Each of the wall members 3X1, 3X2, 3Y1, 3Y2 and the 3C1 to 3C4 has oblique surfaces 3P through which the wall member is bonded to the respective adjacent wall members. Each oblique surface 3P is such that a line perpendicular to the oblique surface 3P makes an acute angle with a line perpendicular to the rear substrate 1 or to the front substrate 2.

FIG. 12 provides orthographic three views of the support body shown in FIG. 11; its top view and two side views. FIG. 12A is viewed from the top, FIG. 12B is from the short side and FIG. 12C is from the long side. Each reference numeral therein refers to the same portion as in FIG. 11.

As shown in FIG. 12, the support body 3 of this example consists of two short-side wall members 3X1 and 3X2, two long-side wall members 3Y1 and 3Y2 and four corner wall members 3C1, 3C2, 3C3 and 3C4. The support body 3 is constructed by bonding them together via their oblique surfaces 3P.

Further, Japanese Patent Laid-Open No. 2000-311630 (Patent Document 2) describes a technique in which a support body includes a first frame member which encloses field emission elements and a second frame member which encloses the first frame member, these first and second frame members are formed by arranging and fixing a plurality of plate-like members in a rectangular shape and welding the respective contact portions by heating with a burner.

Further, Japanese Patent Laid-Open No. 1999-317164 (Patent Document 3) discloses a technique on a display device having a single-piece support frame, wherein frit glasses each having a different softening temperature are used for bonding between the front substrate and the spacers, between the rear substrate and the spacers and between the support frame and the rear and front substrates. This reduces the number of bonding operations, minimizes the dimensional changes and suppresses the minor leaks.

In the above-mentioned conventional art wherein two glass plates are bonded together via a single-piece support frame, it is difficult to handle the support body without damaging it if the display device (screen size) is large. In addition, such a single-piece support frame is likely to waste more in blank cutout, resulting in a higher cost.

To prevent such a problem, it is proposed to construct a support body by assembling/bonding a plurality of separate members as shown in FIG. 11 and so on. This assembling/bonding structure has a cost advantage over the above-mentioned single-piece support frame structure since it reduces the risk of damaging the support body and allows more economical blank cutout.

However, when the two substrates are bonded to the support body via a sealing material by applying a load to them perpendicularly (along the Z direction) to the two substrates, the load is shifted toward the direction to separate joint portions of adjacent constituent members of the support body (along the X or Y direction) from each other. Thus, this pressure bonding may result in poor air-tightness of each junction, causing the occurrence of leak therefrom. To prevent such a situation, it is necessary to use a jig.

In the subsequent evacuation process, the jig must be used again to prevent the constituent members of the support body from shifting since the bonding material at each junction may be dissolved due to the raised ambient temperature. One of challenges in this technical field has been to eliminate the above drawback.

In the conventional art, the plurality of plate-like members are arranged and fixed in a rectangular shape, and the contact portions are heated and melt by burners thus forming the support body by welding. The conventional art requires a shaping step to cope with the occurrence of the deformation attributed to welding. Since there are drawbacks that heating by burners adversely affects the operational environment, operational efficiency and the like, the use of the conventional art is avoided. The technique which fixes members of the support body using the adhesive material has been favorably used.

As a solution to the aforementioned leakage problem with a display device wherein a front and rear substrates are hermetically bonded to end faces of a support body formed of a plurality of support body members via bonding members, it is proposed to use different adhesion agents for bonding together support body members and for fixing the support body to the substrates. This configuration is disclosed in Japanese Patent Laid-Open No. 2005-222895 (Patent Document 4).

In this configuration, to ensure the bonding strength and sealing ability of the bonding material used for assembling the support body, the bonding operation must be such that the bonding material is pushed out (protrudes) from each junction of the support body. As well, the protruded bonding material must be pressed at a sealing temperature during the panel sealing (during seal frit welding). However, if the frit used to bond together the constituent pieces of the support body softens at the sealing temperature during the panel sealing, the constituent pieces may be dislocated when the frit is preliminarily baked and when the panel is sealed, resulting in the leakage.

### SUMMARY OF THE INVENTION

The present invention was made to solve this problem. It is an object of the present invention to provide a display device which is improved in quality and reliability by suppressing the occurrence of leakage attributable to dislocations during the preliminary baking and during the panel sealing.

According to the present invention, to achieve the above object, a display device, in which a front substrate, a rear substrate and a support body are bonded so as to form a hermetically sealed space therein, is characterized in that the support body is formed of a plurality of constituent pieces by bonding them together and plural kinds of bonding materials exhibiting different softening temperatures are used to hermetically bond each constituent piece to the adjacent one. Since this configuration reduces the possibility of dislocation during the preliminary baking and during the panel sealing, it is possible to solve the problem of the related art.

According to one aspect of the present invention, there is provided a display device which comprises a first bonding material for bonding the central area of each constituent piece's bonding surface and a second bonding material for bonding the marginal area around the central area wherein the softening temperature of the first bonding material is higher than that of the second bonding material. Since this reduces the possibility of dislocation during the preliminary baking and during the panel sealing, it is possible to solve the problem of the related art.

According to another aspect of the present invention, there is provided a display device which comprises bonding materials whose softening temperatures are higher than that of the sealing material. Since this reduces the possibility of dislocation between constituent pieces of the support body during the panel sealing, evacuation and other operations, airtight bonding is secured without using a jig currently indispensable. This considerably raises the productivity and solves the problem of the related art.

According to the present invention, plural kinds of bonding materials exhibiting different softening temperatures are used to bond each constituent piece of the support body to the adjacent one. Since a bonding material does not soften during a manufacture process if the softening temperature of the material is higher than a temperature during the manufacture process, it is possible to secure airtight bonding and eliminate the risk of vacuum leak by reducing the possibility of mutual dislocation between constituent pieces of the support body. Thus, the present invention brings about such a great effect that a display device can be realized with high quality and high reliability since it is possible to remarkably improve the air-tightness.

Further, according to the present invention, a first bonding material and a second bonding material are used and designed such that the first bonding material has a higher softening temperature than the second bonding material; the second bonding material protrudes from each junction when the constituent pieces of the support body are bonded together; and the protruded second bonding material is pressed so as to fit the adhesion of the sealing material to the front and rear substrates when the panel is sealed. This secures airtight bonding, eliminates the risk of vacuum leak and improves the mechanical strength. Thus, the present invention brings about such a great effect that a display device can be realized with high quality and high reliability since it is possible to remarkably improve the air-tightness.

Further, according to the present invention, since the support body is formed of a plurality of constituent pieces, it is possible not only to solve the problem of breakage with the single-piece support body but also to prevent waste with respect to blank cutout. Thus, the present invention brings about such a great effect that a high quality, high reliability and large screen display device can be obtained easily since the constituent pieces of the support body can realize a leak free airtight bonding structure at a low cost.

Further, according to the present invention, since mutual dislocation is not likely to occur between constituent pieces of the support body during the sealing, evacuation and other operations, highly airtight bonding is secured without using a jig or other complicated tool which is currently indispensable. Thus, the present invention brings about such a great effect that a high productivity large screen display device can be realized since the manufacture is facilitated.

Needless to say, the present invention is not limited to the above-mentioned constructions and the embodiments described later. Various modifications can be made to them without departing from the technical concept of the present invention.

### BRIEF DESCRIPTION OF THE DRAWINGS

FIG. 1 is a developed perspective view of a display device according to a first embodiment of the present invention.

FIG. 2 is a top view of the support body shown in FIG. 1.

FIGS. 3A and 3B each show a junction between constituent pieces of the support body. FIG. 3A is an enlarged cross-sectional view taken along line A-A′ of FIG. 2. FIG. 3B is an enlarged sectional view taken along line B-B′ of FIG. 2.

FIG. 4 is an enlarged top view of a part where protrusion occurs upward and downward from the outline of the bonding surface.

FIG. 5 is an enlarged schematic top view for explaining the relation between the width of the support body and the width of the protrusion.

FIG. 6 is an enlarged cross-sectional view of a junction after the panel is assembled in the display device of the present invention.

FIG. 7 is an enlarged sectional view of a junction between support body members for explaining a display device according to a second embodiment of the present invention.

FIG. 8 is a top view of a support body for explaining a display device according to a third embodiment of the present invention.

FIGS. 9A to 9C each show a plan view of the main part of a structure to combine support body members forming a support body of a display device according to a fourth embodiment of the present invention.

FIG. 10 is a cross-sectional view of a structure of a conventional display device.

FIG. 11 is a developed perspective view for schematically explaining how a conventional display device is constructed.

FIG. 12 provides top and side views of the conventional support body shown in FIG. 12.

Reference Numerals are briefly explained as follows:
1. Rear Substrate
2. Front Substrate
3. Support Body
4. Sealing Member
5. Electron Source
6. Phosphor Layer
7. Spacer
8. Bonding Member
13. Support Body
13X1. Long-side Support Body Member
13X2. Long-side Support Body Member
13Y1. Short-side Support Body Member
13Y2. Short-side Support Body Member
13P. Bonding Surface
13Q. Outline of Bonding Surface
14. Bonding Members
141. First Bonding Member
142. Second Bonding Member
143. Protruded Portion

### DETAILED DESCRIPTION OF THE PREFERRED EMBODIMENTS

Embodiments of the present invention will be described below with reference to the drawings. Needless to say, although the present invention is applied to FEDs, the present invention can also be applied to similar devices which display images or other display devices.

### First Embodiment

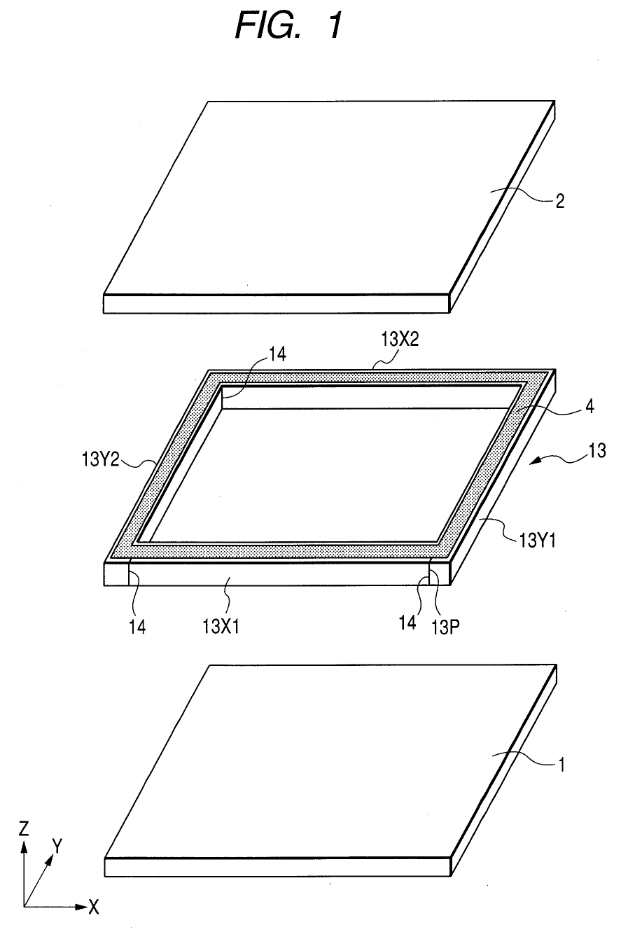

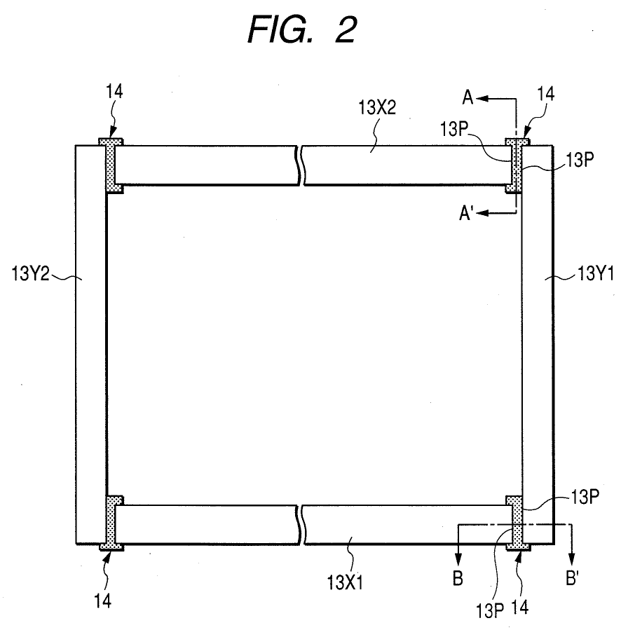

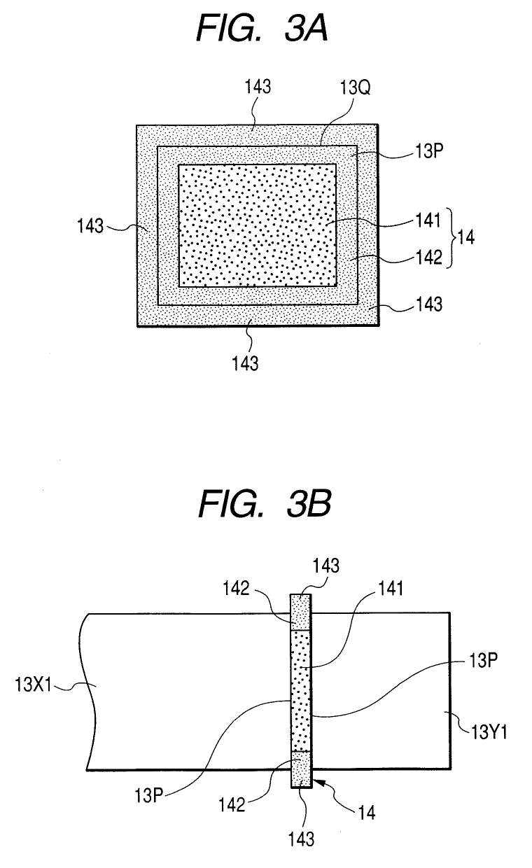

FIG. 1 is a developed perspective view of a display device according to a first embodiment of the present invention. Also, FIG. 1 schematically explains how a rear substrate, a front substrate and a support body are assembled. In the figure, the Z axis indicates the direction in which the front substrate 2 and the rear substrate 1 are stacked. FIG. 2 is an enlarged cross-sectional view of the support body shown in FIG. 1. FIG. 3 shows a junction between constituent pieces of the support body. FIG. 3A is an enlarged cross-sectional view taken along line A-A′ of FIG. 2. Likewise, FIG. 3B is an enlarged sectional view taken along line B-B′ of FIG. 2.

In this display device, the rear substrate 1 and the front substrate 2 are formed of a glass plate and the support body 13 is made of a glass material. Here, various components such as electron sources, phosphor layers and the like which are formed on respective inner surfaces of the rear substrate 1 and the front substrate 2 are omitted from the drawing.

In FIGS. 1 to 3, the rear substrate 1 and the front substrate 2 are arranged to face each other with a fixed gap therebetween. The support body 13 having a given thickness is interposed between a periphery of the rear substrate 1 and that of the front substrate 2. Further, the support body 13 is hermetically fixed to the rear substrate 1 and the front substrate 2 using a sealing material 4 applied to the top and bottom surfaces of the support body 13, thus forming a sealed space therein which constitutes a display region.

The support body 13 includes two long-side support body members 13X1 and 13X2 and two short-side support body members 13Y1 and 13Y2. These support body members 13X1, 13X2, 13Y1 and 13Y2 are sized and assembled so as to surround the display region to be enclosed. They are hermetically bonded to each other at respective bonding surfaces 13P using a bonding material 14 such as frit glass. In this construction, each bonding surface 13P is perpendicular to each substrate.

As the bonding material 14, a first bonding material 141 and a second bonding material 142 are used. They are frit glasses which have different glass properties from each other. For example, the first bonding material 141 is an amorphous frit glass having a softening temperature of about 420 degrees C. (bonding temperature: about 460 degrees C.) while the second bonding material 142 is an amorphous frit glass having a softening temperature of about 380 degrees C. (bonding temperature: about 420 degrees C.) lower than that of the first bonding material 141.

Although these frit glasses have various compositions, an amorphous frit glass may essentially consist of, for example, PbO: about 70 wt %, B₂O₃: about 4 wt % and TiO₂: about 9 wt % and other substances can be used. The softening temperature of the frit glass can be controlled by changing the contents of oxides. For example, increasing the content of an low melting point oxide lowers the softening temperature while increasing the content of a high melting point oxide raises the softening temperature. It is also possible to control the softening temperature of frit glass by changing the relative proportions of constituent elements as already disclosed in glass handbook and so on.

For the bonding materials 14, the first bonding material 141 is applied to the central area of each bonding surface 13P as shown in FIG. 3A and 3B. The second bonding material 142 of which softening temperature is lower than that of the first bonding material 141 is applied to the marginal area around the central area. With the thus applied bonding materials 14, the bonding surfaces 13P of the support body members 13X1, 13X2, 13Y1 and 13Y2 are hermetically bonded to each other.

The amount of the first bonding material 141 with a high softening temperature to be applied to each bonding surface 13P is determined so that there is no protrusion to the surrounding marginal area toward the inside or outside even if pressed by assembling the frame. The second bonding material 142 having a lower softening temperature than the first bonding material 141 is applied to the marginal area of each bonding surface 13P and will be flattened and protruded outward when the frame is assembled.

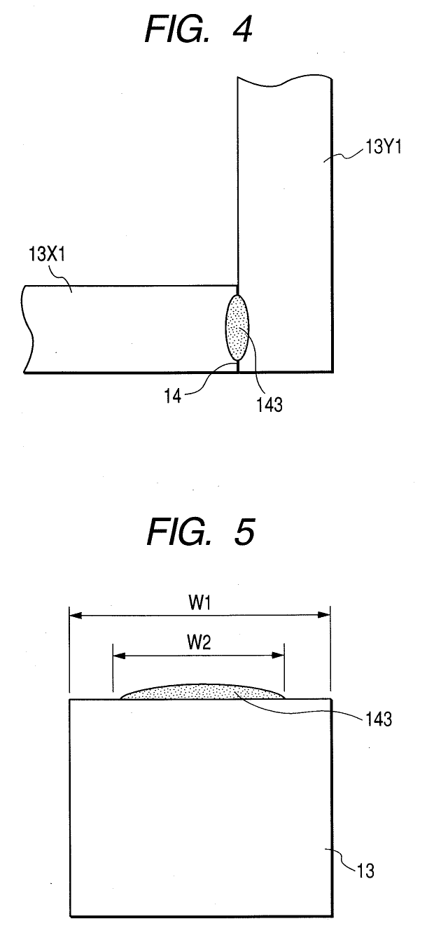

During the panel sealing operation, however, the protruded second bonding material 142 will soften due to the temperature and protrude outward from the top, bottom, right and left sides of the outline 13Q of the bonding surface 13P as shown in FIG. 3A. Reference numeral 143 in the figure refers to the outward protrusive area of the softened second bonding material 142. As shown in FIG. 4, a top view of the relevant part, a protrusion from the outline 13Q of the bonding surface 13P will be pressed into an ellipse by the front and rear substrates at a temperature when the panel is sealed.

In this structure, even if the adhesion of the pressed protrusions 143 to the front substrate 2 and rear substrate 1 is not sufficient, the sealing material 4 present around them can compensate for the insufficiency of adhesion to the front substrate 2 and rear substrate 1 although this is not illustrated in the figure.

FIG. 5 is an enlarged schematic top view for explaining the relation between the width of the support body 13 and the width of the protrusion 143. The ratio of protrusion width W2 to the width W1 of the support body 13 is not smaller than 30%. Preferably, the ratio is not smaller than 60% if possible. If this protrusion width is smaller than 30%, it may be hard for the sealing material 4 to cover the protrusion free area. This may lead to vacuum leak and insufficient mechanical strength.

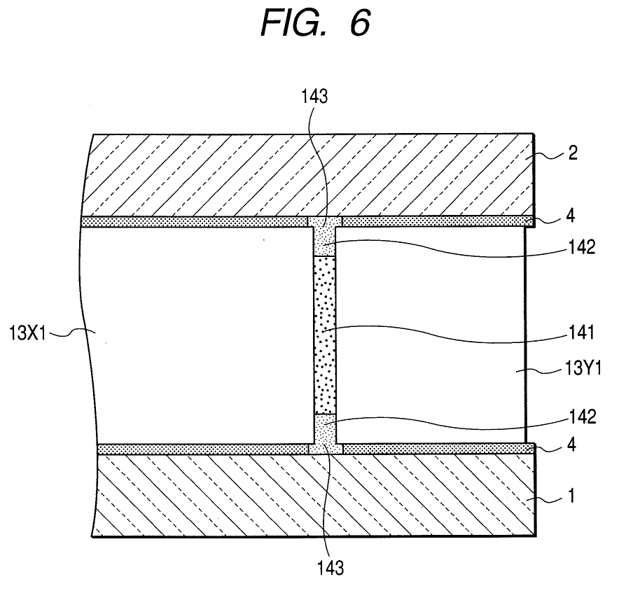

FIG. 6 is a cross sectional view of a relevant part taken along line B-B′ of FIG. 2. In FIG. 6, the rear substrate 1 and the front substrate 2 are arranged to face each other with a fixed gap. The support body 13 (13X1 and 13Y1) is interposed between the substrates and placed at their peripheries. The rear substrate 1 and the front substrate 2 are fixed to the support body 13 by the sealing material 4 applied to the top and bottom surfaces of the support body 13, thus forming the sealed space therein which constitutes the display region.

As this sealing material 4, for example, an amorphous frit glass having a softening temperature of about 350 degrees C. (sealing temperature: about 390 degrees C.) is used. This softening temperature is about 60 degrees C. lower than that of the bonding materials 14 (first bonding material 141 and second bonding material 142). That is, the sealing material 4, the first bonding material 141 and the second bonding material 142 have a relation of the following: first bonding material 141>second bonding material 142>sealing material 4 in terms of a softening temperature.

The difference in the softening temperature between the second bonding material 142 and the sealing material 4 is set to be about 0 to 70 degrees C. Likewise, the softening temperature difference between the first bonding material 141 and the second bonding material 142 is set to be about 20 to 120 degrees C. There is no problem to use the same material for both the second bonding material 142 and the sealing material 4. It is also possible to use press-molded amorphous frit glass powders as the first bonding material 141 and the second bonding material 142 while applying and baking an amorphous frit glass-contained paste as the sealing material 4. In the present embodiment, the sealing material 14, the second bonding material 142 and the first bonding material 141 have softening temperatures of about 350 degrees C., 380 degrees C. and 420 degrees C., respectively.

The following describes an example of a method to form the support body 13. At first, a paste is applied to the central area of each bonding surface of the support body members 13X1, 13X2, 13Y1, and 13Y2. This paste is prepared as the first bonding material 141 by mixing an amorphous frit glass (softening temperature: about 420 degrees C., bonding temperature: about 460 degrees C.) with a certain binder. The second bonding material 142 is applied to the marginal area. The second bonding material 142 is also a paste prepared by mixing an amorphous frit glass (softening temperature: about 380 degrees C., bonding temperature: about 420 degrees C.) with a certain binder. Then, the support body members are arranged properly in a jig. While applying a pressure, they are heated at a bonding temperature of about 460 degrees C. for 10 minutes and then cooled down to form the support body 13.

Then, a paste is applied to the top and bottom surfaces of the support body 13. This paste is the sealing material 4 prepared by mixing an amorphous frit glass (softening temperature: about 350 degrees C., bonding temperature: about 390 degrees C.) with a certain binder. The applied paste is preliminarily baked at about 150 degrees C., which is a temperature sufficient to dissipate the binder, resulting in forming the support body assembly.

According to the present embodiment, it is structurally easy to form the support body members 13X1, 13X2, 13Y1 and 13Y2 and assemble the support body 13. In addition, each bonding surface 13 of the support body members 13X1, 13X2, 13Y1 and 13Y2 is perpendicular to the substrates. The high softening temperature first bonding material 141 is used to bond the central areas of each bonding surface 13P to each other. The low softening temperature second bonding material 142 is used to bond the marginal areas of each bonding surface 13P to each other. The sealing material 4 whose softening temperature is lower than that of the second bonding material 142 is used to bond the support body 13 to the rear substrate 1 and the front substrate 2 at a temperature higher than the softening temperature of the second bonding material 142. The protrusive portions 143 of the second bonding materials 142, which protrude from the bonding surface 13P can be softened and pressed during the sealing using the sealing material 4.

However, since the first bonding member 141, which has been bonded with the central areas of each bonding surface 13P, does not soften at a sealing temperature during the panel sealing, mutual dislocation does not occur between adjacent ones of the support body members 13X1, 13X2, 13Y1 and 13Y2. This allows the bonding surfaces 13P to secure reliable airtight bonding between support body members although the bonding areas are small. Therefore, since the occurrence of vacuum leak can be completely avoided, the support body 13 can sufficiently function. As for amorphous frit glasses, although the softening temperature difference is about 50 degrees C. in the present embodiment, substantially the same effect can practically be obtained if the difference is not smaller than about 20 degrees C. From the viewpoint of process margin, it is still preferable to secure 50 degrees C. or more as the softening temperature difference.

### Second Embodiment

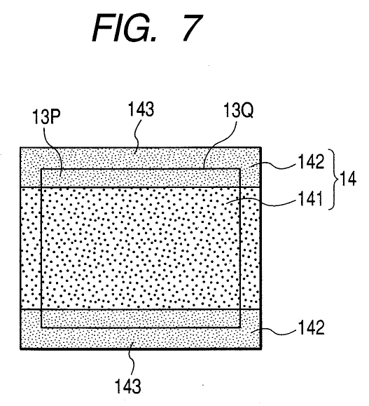

FIG. 7 is an enlarged sectional view for explaining a display device according to a second embodiment of the present invention. FIG. 7 shows a junction taken along line A-A′ indicated in FIG. 2. Each part is given the same reference numeral as the corresponding one in the aforementioned figures and its description is omitted here if the part is identical to the corresponding one. FIG. 7 is different from FIG. 3A in that, for the bonding members 14, the first bonding member 141 is applied to a central transverse area of each bonding surface 13P in the longitudinal direction of each bonding surface 13P while the second bonding member 142 whose softening temperature is lower than that of the first bonding member 141 is applied to the remaining upper and lower areas of the first bonding member 141. The support body members 13X1, 13X2, 13Y1 and 13Y2, not shown in the figure, are hermetically bonded together via their respective bonding surfaces 13P.

Also in this construction, the second bonding member 142 softens at the panel sealing temperature and protrudes upward and downward from the outline 13Q of the bonding surface 13P, forming protruded portions 143. As described with FIG. 4, these protruded portions 143 are pressed into an ellipse-like shape due to the sealing temperature during the panel sealing.

As well, since the first bonding member 141 applied to the central transverse area of each bonding surface 13P does not soften at the panel sealing temperature, mutual dislocation does not occur between adjacent ones of the support body members 13X1, 13X2, 13Y1 and 13Y2. This allows the bonding surface 13P to secure reliable airtight bonding between support body members although the boning area is small. Therefore, the occurrence of vacuum leak can be completely avoided, it is possible for the support body 13 to sufficiently function.

### Third Embodiment

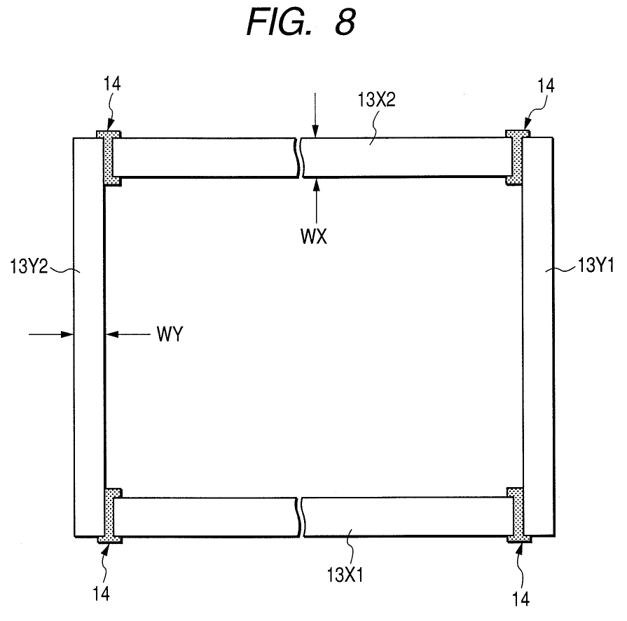

FIG. 8 is an enlarged top sectional view of a support frame for explaining a display device according to a third embodiment of the present invention. Each part is given the same reference numeral as the corresponding one in the aforementioned figures and its description is omitted here if the part is identical to the corresponding one. FIG. 8 is different from FIG. 2 in that two long-side support body members 13X1, 13X2 and two short-side support body members 13Y1, 13Y2, which are combined to form a support body 13 have different widths.

That is, width WX of the two long-side support body members 13X1 and 13X2 is larger than width WY of the two short-side support body members 13Y1 and 13Y2 (WX>WY). The two long-side support body members 13X1 and 13X2 are sandwiched between the two short-side support body members 13Y1 and 13Y2 via bonding members 14 which are structured as described above with FIG. 3A or FIG. 7.

In this construction, the two long-side support body members 13X1 and 13X2 and the two short-side support body members 13Y1 and 13Y2 are bonded via larger bonding surfaces. Increasing the perpendicular bonding surfaces contributes to securing the reliability of bonding in air-tightness and mechanical strength. Thus, this construction remarkably improves the reliability against vacuum leak, allowing the support body 13 to fully perform its function.

### Fourth Embodiment

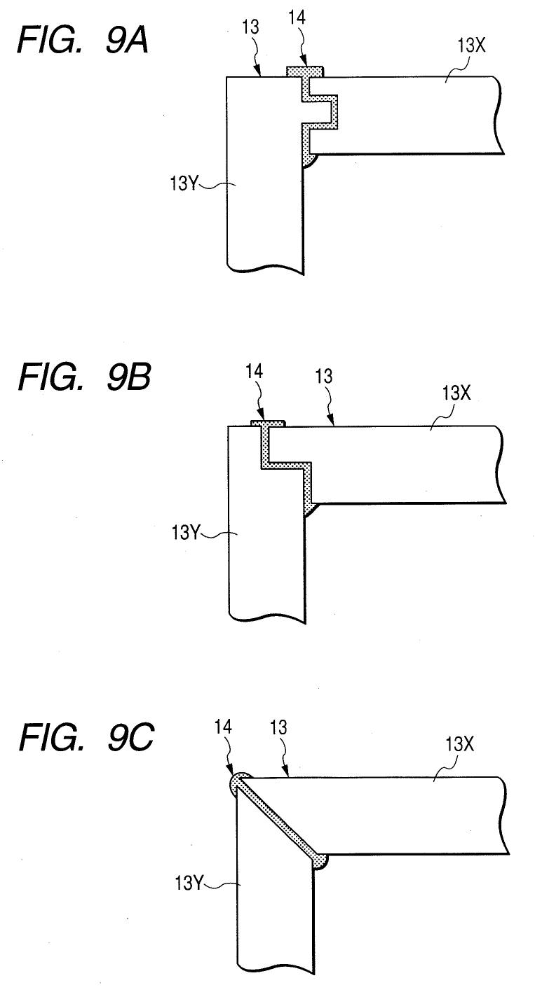

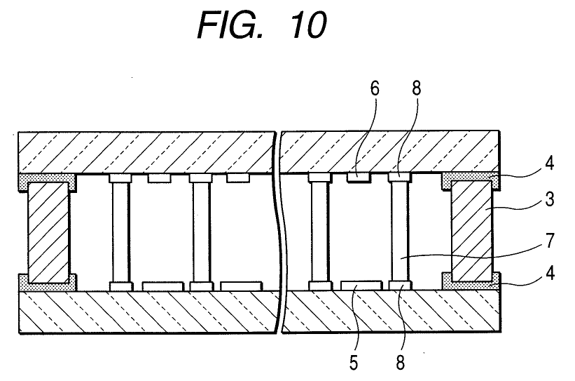

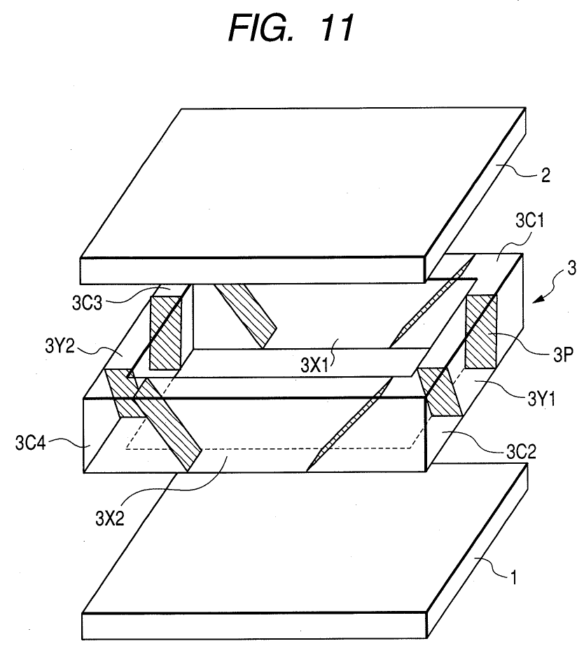

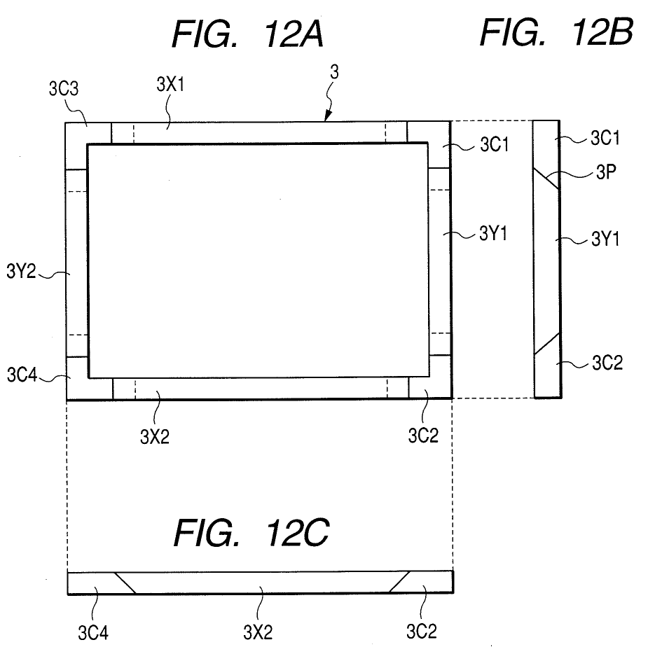

FIGS. 9A to 9C each shows a plan view of the main part of a structure to combine support body members forming a support body of a display device according to a fourth embodiment of the present invention. Each part is given the same reference numeral as the corresponding one in the aforementioned figures and its description is omitted here. In FIG. 9A, a long-side support body member 13X and a short-side support body member 13Y have umbilical bonding surfaces. They are hermetically bonded via bonding members 14 (first and second bonding members 141 and 142) between the umbilical bonding surfaces. Since this can make the bonding area larger, it is possible to improve the mechanical strength and the reliability of air-tightness against vacuum leak.

In FIG. 9B, a long-side support body member 13X and a short-side support body member 13Y have stepped bonding surfaces. They are hermetically bonded via bonding members 14 (first and second bonding members 141 and 142) between the stepped bonding surfaces. Similarly to the structure of FIG. 9A, since this can make the bonding area larger, it is possible to improve the mechanical strength and the reliability of air-tightness against vacuum leak.

In FIG. 9C, a long-side support body member 13X and a short-side support body member 13Y have diagonal bonding surfaces. They are hermetically bonded via bonding members 14 (first and second bonding members 141 and 142) between the diagonal bonding surfaces. Similarly to the structure of FIG. 9A, since this can make the bonding area larger, it is possible to improve the mechanical strength and the reliability of air-tightness against vacuum leak.

Note that the present embodiment does not limit the bonding surfaces of the long-side support body member 13X and short-side support body member 13Y to the umbilical structure, stepped structure and diagonal bonding structure as described above. The same effect can also be obtained by combining these bonding structures or by employing, for example, a bonding structure which has a small concavity and convexity (concavities and convexities).

What is claimed is:

1. A display device comprising:
a front substrate which has an anode and phosphors on the inner side of the front substrate;
a rear substrate which has a plurality of electron sources on the inner side of the rear substrate and is arranged to face the front substrate with a certain distance;
a support body interposed between the front substrate and the rear substrate so as to surround a display region and maintain the distance between the front substrate and the rear substrate; and
a sealing member which hermetically bonds the end surfaces of the support body to the front substrate and the rear substrate;
wherein the support body is formed by hermetically bonding a plurality of support body members by using a plural kinds of bonding members for bonding together the bonding surfaces of adjacent support body members, the plural kinds of bonding members being different in softening temperature from each other.

2. The display device according to claim 1, wherein
the bonding members comprise a first bonding member for bonding a central area of each of the bonding surfaces and a second bonding member for bonding a marginal area around the central area; and
the softening temperature of the first bonding member is set higher than the softening temperature of the second bonding member.

3. The display device according to claim 1, wherein
the bonding members comprise a first bonding member for bonding a central transverse area of each of the bonding surfaces and a second bonding member for bonding marginal areas above and below the central transverse area; and
the softening temperature of the first bonding member is set higher than the softening temperature of the second bonding member.

4. The display device according to claim 1, wherein
the softening temperature difference between the first bonding member and the second bonding member is not smaller than 20 degrees C.

5. The display device according to claim 1, wherein
each junction between support body members has protruded portions of the second bonding member which is protruded out of the bonding surfaces.

6. The display device according to claim 5, wherein
the width of the protruded portions is not smaller than 30 percent of the width of the bonding surfaces.

7. The display device according to claim 5, wherein
the protruded portions of the second bonding member is pressed into an ellipse-like shape by the front substrate and the rear substrate.

8. The display device according to claim 1, wherein the bonding members are made of amorphous frit glass.

9. The display device according to claim 1, wherein the sealing member is made of amorphous frit glass.

10. The display device according to claim 1, wherein the softening temperature of the sealing member is lower than the softening temperatures of the bonding members.

11. The display device according to claim 1, wherein the softening temperature difference between the sealing member and the second bonding member is not higher than 70 degrees C.
